(19) United States
(12) Patent Application Publication
(10) Pub. No.: US 2006/0217123 A1
(43) Pub. Date: Sep. 28, 2006

(54) Radio base resource allocation method and radio base station

(75) Inventors: Hidenori Ishii, Setagaya-ku (JP); Kenji Takagi, Yokohama-shi (JP); Go Nakano, Shibuya-ku (JP); Tsutomu Ishii, Shinagawa-ku (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 10/551,047

(22) PCT Filed: Mar. 18, 2004
(86) PCT No.: PCT/JP04/03619

§ 371 Date: Sep. 27, 2005

(30) Foreign Application Priority Data
Apr. 3, 2003 (JP) 2003-100017

(51) Int. Cl. H04B 1/38

(52) U.S. Cl. 455/450

(57) ABSTRACT

It is an object to achieve both improvements in system capacity and load distribution, by allocating resources so as not to generate the call loss as possible. A protected call is set, the resource allocating scheme is varied according to the resource state of each card, call allocating processing is performed to distribute loads at the low traffic time, while being performed to use up as possible resources of a card with a high in-use rate at the high traffic time, and it is thereby possible to obtain the advantageous effect of using resources with high efficiency to enable the load distribution over signal processing cards without generating the call loss as possible.

### TECHNICAL FIELD

The present invention relates to a resource management scheme to suitably allocate resources in a radio base station that holds terminals performing wireless communications.

### BACKGROUND ART

In recent years, cellular telephones have achieved remarkable widespread use, and cellular telephone service in the W-CDMA (Wideband Code Division Multiple Access) standard first started in Japan in 2001. In regard to communication techniques, digital cellular telephones have provided only speech and low-rate packet communications, but introduction of W-CDMA has enabled wideband transmission, and for example, service of 384 kbps is started as of 2002.

Networks of W-CDMA are comprised of a switching apparatus, RNC (Radio Network Controller), BTS (Base Transceiver Station) and the like. The BTS performs wireless communications with a cellular phone terminal, and converts signals into those for the networks. Various applications are provided in W-CDMA taking advantage of wideband transmission, and as types of traffic occurring in a cover area of the BTS, calls of high-rate transmission have increased for a video conference, high-rate packet transmission and the like. With such increases, it is required to effectively use the holding capability of the BTS having limitations by improving the resource management scheme. In addition, the resource in the invention basically represents a processing capability required for baseband processing inside the BTS, and is different from radio resources representing strength of radio signal of each channel and the like.

FIG. 1 shows a configuration example of the conventional technique related to the resource allocation scheme.

In FIG. 1, reference numeral “11” denotes a terminal. In following descriptions, assumed as terminal 11 is a 3rd generation cellular phone of the W-CDMA system or MC-CDMA (Multi-Carrier CDMA), but other cellular phones and cordless phones are also applicable such as GSM (Global System for Mobile communications), PHS (Personal Handy-phone System) and PDC (Personal Digital Cellular).

Reference numeral “12” denotes a base station which holds terminal 11, and transmits and receives radio signals to/from terminal 11 to convert into signals for wired communications (wired signals). Reference numeral “13” denotes a network having the switching function. Network 13 is connected to base station 12 via a dedicated line and ATM (Asynchronous Transfer Mode).

Reference numerals “14” to “18” denote internal structural elements of base station 12. Reference numeral “14” denotes wireless communication means for transmitting and receiving radio signals to/from terminal 11. Wireless communication means 14 controls transmit power of an antenna and terminal 11 and performs other processing such as modulation in frequency. Wireless communication means 14 is provided with the antenna, amplifier, power supply for transmission, and control program.

Reference numeral “15” denotes connection control means for controlling connection/disconnection of a communication channel to terminal 11 corresponding to a request of network 13. Connection control means 15 is installed as a program in a control card in base station 12. Reference numeral “16” denotes signal processing means for performing code modulation processing of radio signals from terminal 11, signal processing for converting the signals into wired signals, and the like. In order to hold a large number of terminals at the same time in base station 12, signal processing means 16 has a large number of cards of the same format, and the cards are referred to as first signal processing card 16a to nth signal processing card 16c. Reference numeral “17” denotes wireless resource control means for performing allocation and deallocation of a placed call to/from a signal processing card in signal processing means 16. Reference numeral “18” denotes wired communication means for transmitting and receiving signals to/from network 13.

The base station 12 holds communication calls of terminal 11. Processing capabilities of first to nth signal processing cards 16a to 16c to perform signal processing of the calls at the time are referred to as resources, and processing for allocating the calls to the signal processing cards when the calls occur is referred to as resource allocating processing.

The performance of the signal processing cards is dependent on the hardware, takes various values, and is assumed herein that each of the signal processing cards has a signal processing capability of 768 kbps, and that one resource is defined as a signal processing capability of 24 kbps. Accordingly, each signal processing card has 32 resources. It is further assumed that base station 12 supports the following types of calls:
(a) Speech call One resource
(b) Non-restricted digital call (64 kbps) Three resources
(c) Packet A call (128 kbps) Six resources
(d) Packet B call (384 kbps) Sixteen resources
(e) Common channel Eight resources

The common channel of (e) is a channel to control all the terminals, and comprised of a BCH (Broadcast CHannel), FACH (Forward Access CHannel), PCH (Paging CHannel), RACH (Random Access CHannel) and the like. In starting communications, terminal 11 performs paging and the like via the common channel. Therefore, when signals cannot be transmitted on the common channel, all the terminals under control of base station 12 cannot communicate. The number of required resources of the common channel increases or decreases depending on the size of a cover area of base station 12 and the number of channels held by base station 12, and is herein assumed, for example, eight.

W-CDMA enables services of many types of calls such as a speech call, packet call, and non-restricted digital call. The transmission rate and the number of resources required for a signal processing card to process a call are varied with a type of the call. In the resource allocating processing, under such environments that many types of calls with the different numbers of required resources appear and disappear repeatedly, two things are required such that limited resources of a base station are effectively used not to cause call losses as possible, and that loads are distributed on a plurality of signal processing cards to reduce the load imposed on each of the signal processing cards.

As the conventional invention regarding the resource allocating processing to distribute loads, for example, such an invention is disclosed in Japanese Laid-Open Patent Publication 2001-119752 (page 4). This Patent Document intends to distribute loads on a plurality of signal processing cards, thereby decrease an average processing amount on each of the signal processing cards, and reduce the cost required for installation of the signal processing cards. Further, when processing is centered on one card and the card fails, adverse effects of the card are serious, but distributing loads produces an effect of reducing damage in failure.

In the above-mentioned Patent Document, distribution of loads is achieved by allocating resources in the following procedures:

(J1) After a call arrives, estimate the number of resources required for processing of the call; and

(J2) Among signal processing cards with vacant resources corresponding to the number of resources estimated in (J1), allocate the call to a signal processing card with the smallest number of resources being used (with the largest number of vacant resources).

For example, in the base station having three or more signal processing cards as shown in FIG. 1, when speech calls each requiring one resource occur three times in a row, the calls are allocated as described above.

In allocating a first speech call, since either card is not assigned a call, the first speech call is allocated to a first signal processing card with a lowest number.

In a subsequent speech call, since signal processing cards are not assigned a call except the first signal processing card, the call is allocated to a second signal processing card with a lowest number among the left cards.

In a third speech call, since signal processing cards are not assigned a call except the first and second signal processing cards, the call is allocated to a signal processing card with a lowest number among the left cards.

In the conventional technique, as described above, with respect to a call newly occurring (hereinafter, referred to as a new call), resources are allocated in a signal processing card with the smallest number of in-use resources.

However, in using the resource allocating system to distribute loads as described in the above-mentioned Patent Document, when a traffic amount flowing in a base station is large on the following two preconditions, such a defect arises that small vacant resources are distributed over a plurality of signal processing cards (called fragment), and the efficiency deteriorates.

(A1) A case of using a communication system such as W-CDMA where many types of calls exist and the number of required resources differs among the types of calls; and

(A2) A case of having such a constraint that a single call is allocated to a single signal processing card.

In particular, when the constraint exists that a single call is allocated to a single signal processing card as in (A2), a case sometimes arises that although the total number of vacant resources in a base station is larger than the number of required resources of a newly occurring call, the call cannot be allocated because the number of vacant resources of each card is smaller than the number of required resources. For example, when each of two signal processing cards in a base station has four vacant resources while any other signal processing cards have no vacant resources, the number of vacant resources of each card is smaller than six that is the number of required resources of a packet A call. Accordingly, although there are eight (=4×2) vacant resources in the entire base station, the packet A call cannot be allocated in this case.

Particularly, since the algorithm of the above-mentioned Patent Document intends to distribute loads, when the traffic amount is large, the number of allocated resources increases in all the cards, and vacant resources tend to be distributed over a plurality of cards. Accordingly, the possibility becomes high that a call with the large number of required resources cannot be allocated. For example, when four signal processing cards exist each with 32 resources installed therein and 68 speech calls occur all of which have one required resource, each signal processing card is assigned 17 calls, and has 15 vacant resources. In this case, the base station has 60 vacant resources as a whole, but cannot accommodate a packet B call with 16 required resources.

Further, when a signal processing card holding the common channel develops trouble, the common channel is newly assigned to another signal processing card to maintain communications with terminals. However, in the algorithm of the above-mentioned Patent Document, since presence of the common channel is not considered, even when vacant resources exist to accommodate a common channel in the entire base station, it is not possible to allocate the common channel to other resources because of distribution of vacant resources. Therefore, when the common channel develops failure, there is a possibility that communications between a terminal and the base station is disconnected even during communications with the terminal.

### DISCLOSURE OF INVENTION

It is an object of the present invention to provide a resource allocating method in a radio base station and the radio base station enabling both improvements in capacity efficiency and distribution of loads by allocating resources not to generate call losses as possible.

In the invention, the aforementioned object is achieved by monitoring states of signal processing cards, judging whether a traffic level is low or high at some point based on the number of required resources of a call of a type whose loss is to be avoided (protected call) from processing loads (the number of resources) of calls held in a base station at that point, and allocating, at the low traffic time, resources to distribute loads only when a call expected to occur can be allocated, while allocating, at the high traffic time, resources not to generate call losses as possible.

According to one aspect of the invention, a resource allocating method in a radio base station is a resource allocating method in a radio base station for allocating a plurality of types of calls to a plurality of signal processing cards, and has at least a step of registering some call as a protected call, a step of comparing a first sum of a resource of the protected call and a resource of a new call with vacant resources of at least two signal processing cards when the new call occurs, a step of defining the time the first sum is more than a vacant resource of each signal processing card as a high traffic time, while defining the time the first sum is less than or equal to the vacant resources of at least two signal processing cards as a low traffic time, and a step of switching a resource allocating scheme between the high traffic time and the low traffic time.

According to another aspect of the invention, a radio base station is a radio base station that controls a plurality of signal processing cards for performing signal processing on communication calls in wireless communications, and has a wireless resource monitor which registers some call as a protected call, compares a first sum of a resource of the protected call and a resource of a new call with vacant resources of at least two signal processing cards when the new call occurs, defines the time the first sum is more than a vacant resource of each signal processing card as a high traffic time, while defining the time the first sum is less than or equal to the vacant resources of at least two signal processing cards as a low traffic time, and switches a resource allocating scheme between the high traffic time and the low traffic time.

### BRIEF DESCRIPTION OF DRAWINGS

FIG. 1 is a configuration diagram of a base station in the conventional technique;

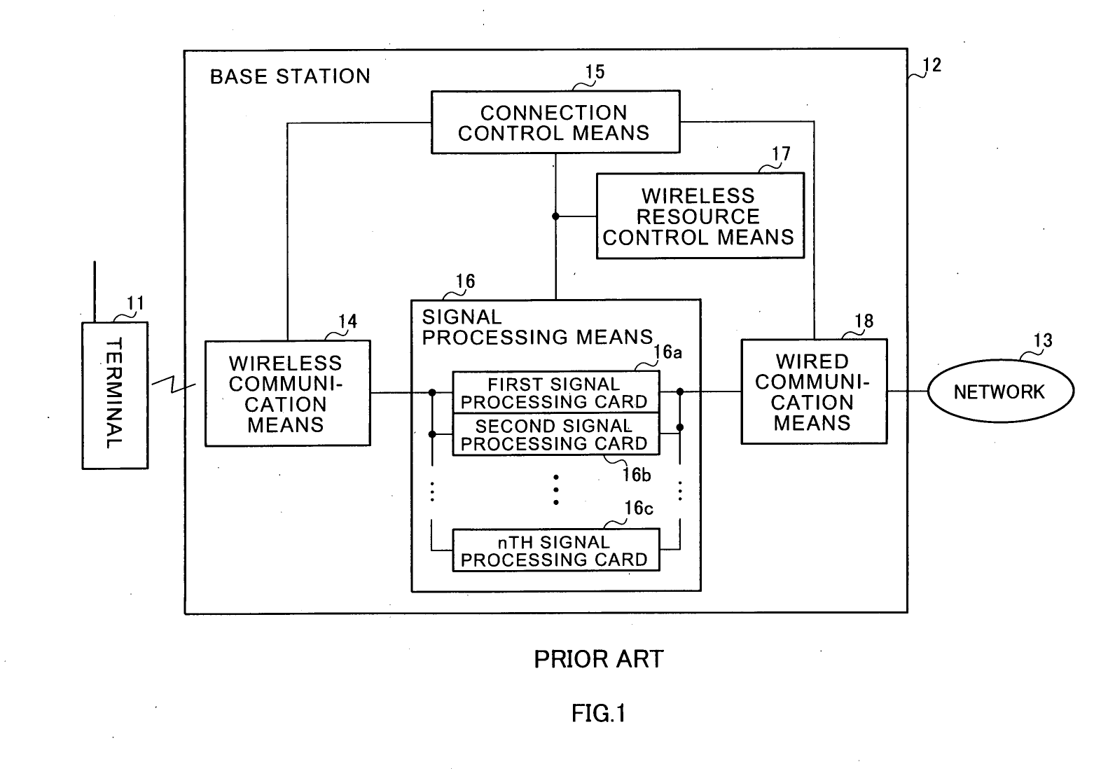

FIG. 2 is a configuration diagram of a base station in Embodiment 1 of the present invention;

FIG. 3 is a state diagram of a signal processing section in Embodiment 1 of the invention;

FIG. 4 is a selection flow diagram of resource allocating processing in Embodiment 1 of the invention;

FIG. 5 is another state diagram of the signal processing section in Embodiment 1 of the invention;

FIG. 6 is a selection flow diagram of resource allocating processing in Embodiment 2 of the invention;

FIG. 7 is a first state diagram of a signal processing section in Embodiment 2 of the invention; and

FIG. 8 is a second state diagram of the signal processing section in Embodiment 2 of the invention.

### BEST MODE FOR CARRYING OUT THE INVENTION

Embodiments of the present invention will specifically be described below with reference to accompanying drawings. In addition, the present invention is not limited to the embodiments, and is capable of being carried into practice with various modifications thereof without departing from the scope of the subject matter thereof.

### Embodiment 1

Embodiment 1 of the invention will be described below.

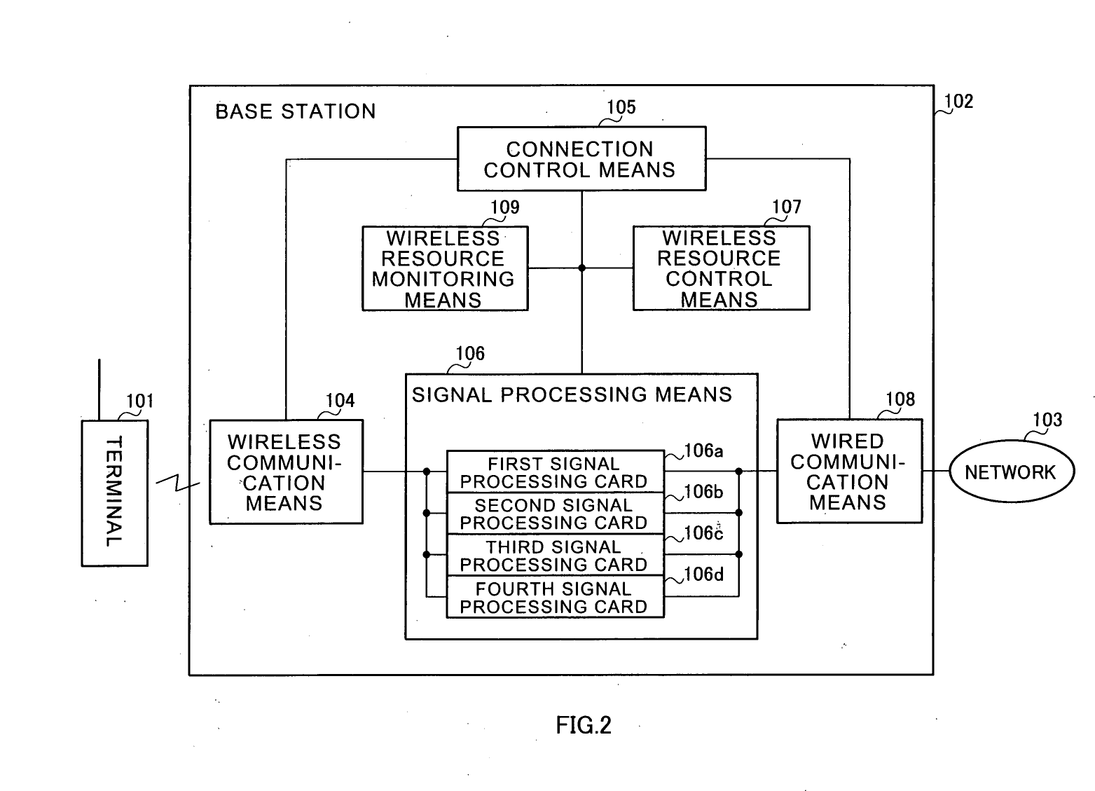

FIG. 2 shows a block configuration diagram of the invention. Reference numerals “101” to “108” in FIG. 2 respectively correspond to reference numerals “11” to “18” explained as the conventional technique.

In FIG. 2, reference numeral “101” denotes a terminal. In following descriptions, assumed as terminal 101 is a 3rd generation cellular phone of the W-CDMA system or MC-CDMA (Multi-Carrier CDMA), but other cellular phones and cordless phones are also applicable such as GSM, PHS and PDC.

Reference numeral “102” denotes a base station which holds terminal 101, and transmits and receives radio signals to/from terminal 11 to convert into wired signals.

Reference numeral “103” denotes a network having the switching function. Network 103 is connected to base station 102 via a dedicated line and a wired transmission path of ATM.

Reference numerals “104” to “109” denote internal structural elements of base station 102.

Reference numeral “104” denotes a wireless communication section which transmits and receives radio signals to/from terminal 101. Wireless communication section 104 controls transmit power of an antenna and terminal 101, and performs other processing such as modulation in frequency. Wireless communication section 104 is provided with the antenna, amplifier, power supply for transmission, and control program.

Reference numeral “105” denotes a connection control section that controls connection/disconnection of a communication channel to terminal 101 corresponding to a request of network 103. Connection control section 105 is installed as a program in a control card in base station 102.

Reference numeral “106” denotes a signal processing section that performs code modulation processing of radio signals from terminal 101, signal processing for converting the signals into wired signals, and the like. In order to hold a large number of terminals at the same time in base station 102, signal processing section 106 is comprised of a large number of cards of the same format, LSIs and hardware composed of combination thereof. It is assumed in this embodiment that base station 102 has four signal processing cards, and the same types of hardware are respectively referred to as first signal processing card 106a, second signal processing card 106b, third signal processing card 106c, and fourth signal processing card 106d. In addition, it is possible to obtain advantageous effects of the invention irrespective of the number of cards, by using at least two signal processing cards.

Reference numeral “107” denotes a wireless resource control section that performs allocation and deallocation of a placed call to/from a signal processing card in signal processing section 106.

Reference numeral “108” denotes a wired communication section that transmits and receives signals to/from network 103.

Reference numeral “109” denotes a wireless resource monitoring means which monitors a state of the signal processing section, and instructs a change of resource allocating scheme to resource control section 107 when necessary.

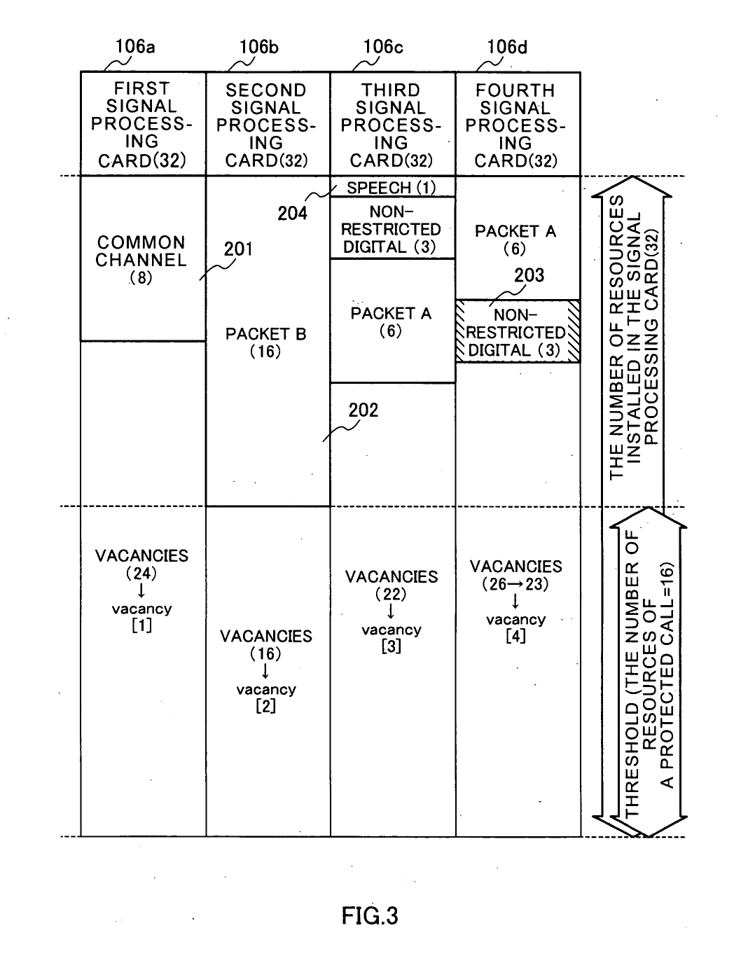

FIG. 3 is explained next. FIG. 3 illustrates a state of signal processing section 106. Herein, the number of signal processing cards in signal processing section 106 is assumed four. Further, as in the example of the conventional technique as described above, each of the signal processing cards is assumed to have a signal processing capability of 768 kbps. One resource is defined as a signal processing capability of 24 kbps. It is further assumed that base station 102 supports following types of calls:
(a) Speech call One resource
(b) Non-restricted digital call (64 kbps) Three resources
(c) Packet A call (128 kbps) Six resources
(d) Packet B call (384 kbps) Sixteen resources
(e) Common channel Eight resources

In addition, the types of calls to support vary with communication providers that provide the communication service. Further, regarding the unit resource, the rate is increased or decreased depending on the hardware of a base station. Furthermore, the unit rate may be sps (Symbols Per Second). In the invention, it is possible to obtain the same advantageous effects even in the case where the number of signal processing cards in signal processing section 106, processing capability of the signal processing card, and/or the unit resource is different. A state of first signal processing card 106a of FIG. 3 will be described below. First signal processing card 106a is only holding a common channel. In the signal processing card, the number of installed resources is “32”, the number of required resources of the common channel is “8”, and therefore, the number of vacant resources is “24” (=32−8). With respect to second signal processing cards 106b to fourth signal processing card 106d, calls held therein are shown. In FIG. 3, each numerical value inside the parentheses after a name of a call indicates the number of resources of the call, and each numerical value inside the parentheses after a name of a signal processing card indicates the number of installed resources of the card.

In this embodiment, any positions are available to hold a call within each processing card. Accordingly, it is only required to recognize the number of vacant resources in a management table in wireless resource control section 107. In this embodiment, the number of vacant resources of the ith signal processing card is represented by vacancy[i].

In addition, when processing capabilities are different between the cards, it is necessary to manage the number of resources installed in each card, as well as the number of vacant resources, but also in this case, the same advantageous effects as in the invention are obtained.

The operation of the resource allocating scheme in base station 102 will be described below.

When base station 102 is activated, the station reserves a common channel for use in paging of terminal 101 and the like. Assuming herein that calls are allocated to cards in ascending order of the card number, wireless resource allocating section 104 allocates resources to process the common channel to first signal processing card 106a. This is shown in FIG. 3 as common channel 201.

In addition, as the method of determining a signal processing card as an allocation destination, various methods are considered such as the method of allocating in ascending order of the card number, in descending order of the card number, in ascending order of the number of vacant resources, or in descending order of the number of vacant resources among all the signal processing cards, and it is possible to obtain the advantageous effects of the invention in either case.

After base station 102 finishes reservation of the common channel, terminal 101 performs position registration and ATTACH (processing for allowing the terminal to receive calls from the network) for network 103. In addition, a dedicated channel is used in the ATTACH processing, and resources are allocated. Also in this case, adding the ATTACH as a type of call enables the advantageous effects of the invention to be obtained. However, for simplicity in descriptions, resources used in ATTACH are not considered in this embodiment.

When terminal 101 issues a packet B of 384 kbps after registering the position, base station 102 establishes a communication channel for use in a call between terminal 101 and network 103, and allocates the packet B call 202 to second signal processing card 106b.

Resource allocating procedures will specifically be described below when terminal 101 issues the packet B call 202. The procedures are the same as in the other types of calls.

First, terminal 101 outputs a dispatch request to network 103 via base station 102 using the common channel. Inside base station 102, wireless communication section 104 receives the request to perform demodulation and the like, and outputs the request to first signal processing card 106a allocated to the common channel in signal processing section 106. First signal processing card 106a performs baseband processing and conversion processing to wired signals, and outputs the dispatch request to wired communication section 108. Wired communication section 108 performs protocol conversion to ATM and the like on the signal to output to network 103. In this embodiment, base station 102 is only controlled by network 103, and not controlled by signal from terminal 101. In addition, the algorithm of the invention is not related to a trigger of the resource allocating processing, and therefore, the advantageous effects of the invention can be obtained similarly also in the case where the resource allocating processing is controlled by signal from terminal 101.

In response to the dispatch request, network 103 outputs a resource reserve request for a packet B call of terminal 101 to base station 102. According to the resource reserve request, base station 102 allocates the call to a proper signal processing card.

Specific descriptions are given below on procedures for base station 102 to allocate resources according to the resource reserve request from network 103. First, the resource reserve request is input to wired communication section 108 from network 103. This request is a control request to base station 102, and connection control section 105 detects the request. Connection control section 105 outputs a request to reserve resources for a packet B call in signal processing section 106 to wireless resource control section 107.

In this embodiment, signal processing cards are allocated in descending order of the number of vacant resources at the low traffic time to distribute loads, while being allocated in ascending order of the number of vacant resources at the high traffic time to reduce call losses caused by distribution of vacant resources. Wireless resource monitoring means 109 monitors a state of signal processing section 106, selects an appropriate scheme between two resource allocating schemes, and instructs wireless resource control section 107 to allocate a call to a signal processing card using the selected scheme.

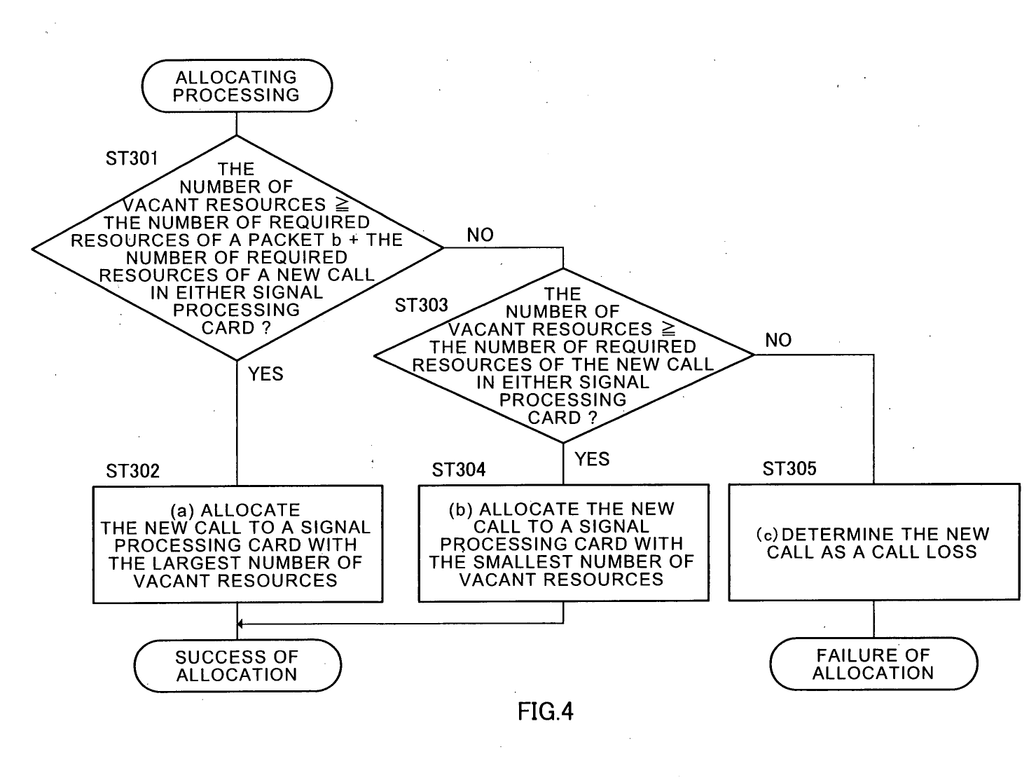

FIG. 4 is a flow diagram of a method of selecting resources. In the invention, by predicting traffic, in order to hold a call expected to have the highest occurring frequency, the number of required resources of this type of call is set as a threshold, and allocation is performed to leave vacant resources corresponding to the threshold in each of signal processing cards as possible. In this embodiment, assuming that the frequency of packet B call of 384 kbps is high as an example, the operation will be described below in the case where the threshold is set at “16” that is the number of required resources of a packet B call, and resources are allocated to leave sixteen vacant resources in each of signal processing cards.

In addition, in this embodiment, such an algorithm is exemplified that enables a packet B call to be held also at the high traffic time. However, it is possible to obtain the advantageous effect of load distribution in this embodiment in other cases such that a type of call allowed to be held at the high traffic time is a different one such as a packet A call and non-restricted digital call, and that a threshold is set to enable a plurality of packets B to be held (in the case of using signal processing cards each capable of accommodating more resources than in the example of this embodiment).

In FIG. 4, in each of the signal processing cards, whether the traffic level is high or low is determined from the possibility of holding a packet B call that is a protection target cal, and according to the result, allocating processing is performed using either method of the following three types, (a) to (c). In subsequent descriptions, the number of required resources of a call to be protected is represented by protected_call, and the number of required resources of a newly occurring call (new call) is represented by new_call. In this embodiment, since the protected call is a packet B call, protected_call=16. The allocating processing will be described below for each condition.

(a) A case where protected_call+new_call≦vacancy[i] holds in either one of ith signal processing card (ST301:YES).

This is equivalent to a case that a signal processing card exists which can hold the protected call (packet B call) when being assigned a new call.

For example, when the new call is a speech call, the sum of the numbers of required resources of the speech call (1) and protected packet B call (16) is “17”, and a signal processing card is present which has seventeen or more vacant resources. When a new call occurs, the call is allocated to a signal processing card with the largest number of vacant resources (ST302). By this means, loads are distributed over the signal processing cards.

(b) A case where protected_call+new_call>vacancy[i] holds in all of the ith signal processing cards, and new_call≦vacancy[i] holds in either one of ith signal processing card (ST301:NO and ST303:YES).

This is equivalent to a case that a new call can be allocated to either card, but when the new call is allocated, signal processing cards lack vacant resources and cannot hold the protected call. In this case, when loads are distributed as in (a), since the number of vacant resources becomes smaller than that of the required resources of the protected call, as many calls as possible are allocated to one card.

When a new call occurs, the call is allocated to a signal processing card with the smallest number of vacant resources among signal processing cards having a number of vacant resources larger than the number of required resources of the allocation target call (ST304). When there is a plurality of signal processing cards with the same number of in-use resources, the call is allocated to a signal processing card with the lowest card number among such cards.

(c) A case where new_call>vacancy[i] holds in all of the ith signal processing cards (ST301:NO and ST303:NO).

This is equivalent to a case that there is no signal processing card to allocate a new call.

The case results in a call loss where no signal processing card exists which has vacant resources more than the number of required resources of the new call (ST305).

In addition, in the case of (c), a method is considered of waiting until the time the other call is disconnected and vacant resources increase, or of waiting for a predetermined time and trying to allocate again, and using either method enables acquisition of the advantageous effect of this embodiment.

In this embodiment, when all the cards do not have vacant resources for the protected call, the processing flow goes to (b). Meanwhile, the advantageous effect of distributing loads according to this embodiment is obtained when the processing flow goes to (b) when part of cards do not have vacant resources for the protected call. Further, in the branch to (a) or (b), compared is protected_call+new_call (the sum of the numbers of required resources of the protected call and new call) and vacancy (the number of vacant resources in a signal processing card). The advantageous effect of distributing loads of this embodiment is also obtained in comparing only protected_call with vacancy.

After allocating the resources, connection control section 105 sets a communication path such that a signal of speech call from terminal 101 is properly output to network 103, using wireless communication section 104, signal processing section 106 (first signal processing card 106a), and wired communication section 108, and outputs a response to the resource reserve request to network 103 via wired communication section 108. In this way, the communication path is established from terminal 101 to network 103. Thereafter, communications with the issue destination of terminal 101 is started by call control of an upper layer, but this portion is not directly related to the invention, and omitted.

The resource allocating processing is carried out on a non-restricted digital call, packet A call and packet B call in the same way as in a speech call except for the number of required resources that is different from one another. When the call is finished, after call disconnecting processing of the upper layer, network 103 outputs a resource deallocation request including designation of the call targeted for deallocation to base station 102.

When connection control section 105 detects the request, the section 105 outputs a request to deallocate the resources to wireless resource control section 107. Wireless resource control section 107 specifies a signal processing card targeted for deallocation, and instructs signal processing section 106 to deallocate the call.

In FIG. 3, before allocating non-restricted digital call 203 to fourth signal processing card 106d, third signal processing card 106c and fourth signal processing card 106d have vacant resources more than “19” (=16(the number of required resources of protected packet B call)+3), and (a) is applied. The number of in-use resources of third signal processing card 106c is “10” (=1 for a speech call+3 for a non-restricted digital call+6 for a packet A call), and therefore, the number of vacant resources is “22” (=32−10). In fourth signal processing card 106d, the number of in-use resources is only “6” for a packet A call, and the number of vacant resource is “26”. Therefore, non-restricted digital call 203 is allocated to fourth signal processing card 106d with the smallest number of in-use resources.

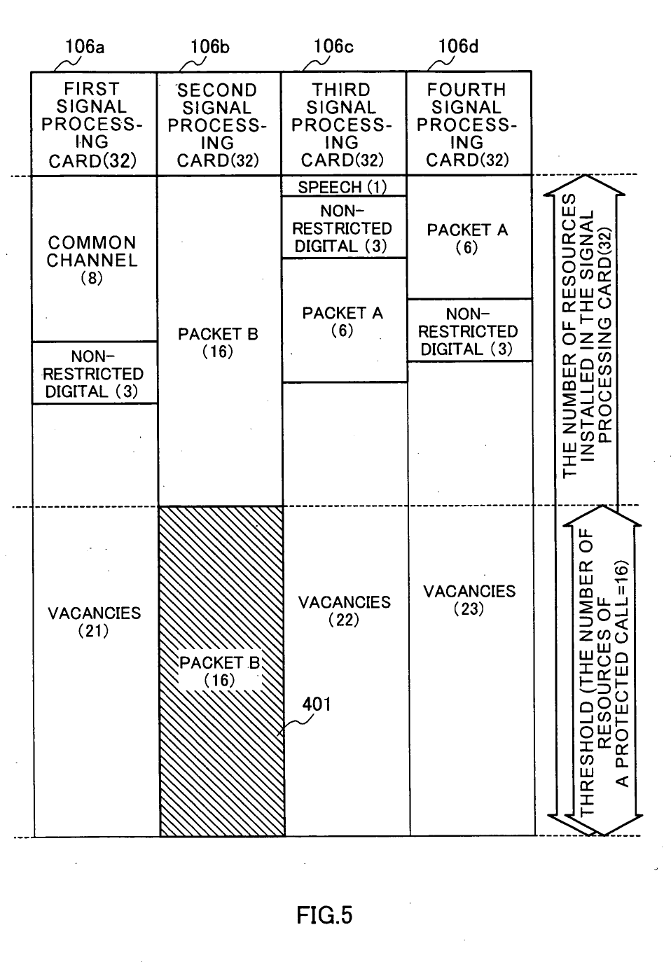

FIG. 5 shows a state where a packet B call occurs after allocation in FIG. 3. In FIG. 5, in allocating packet B call 401 to second signal processing card 106b, since any signal processing cards do not have 32 (=16+16) vacant resources, (b) is applied. Accordingly, packet B call 401 is allocated to second processing card 106b with 16 in-use resources that is the largest number.

In this embodiment, a position of resource(s) for a single call does not need to be in a row in a signal processing card. For example, when speech call 204 is deallocated from third signal processing card 106c from the state in FIG. 3, instead of regarding vacant resources as two portions having one vacancy and 22 vacancies, the vacant resources are regarded as one portion having 23 vacancies.

In addition, when the speech call is deallocated from the third signal processing card in FIG. 3, the algorithm of this embodiment is also applicable to the case where vacant resources are divided into two blocks, one with one vacant resource and the other one with twenty two vacant resources. In this case, by detecting presence or absence of successive resources to accommodate a packet B call, the resource allocating processing to distribute loads is applied when successive resources are present and can accommodate a packet B call, while the processing is switched to the efficiency-oriented algorithm when a packet B call cannot be allocated. Accordingly, the case of there being twenty two vacant resources is determined as low traffic, and the load-distribution scheme is selected for allocation. Further, as the efficiency-oriented algorithm, there may be the method of allocating a new call to a signal processing card with the maximum in-use percentage as in this embodiment, and a method of allocating a new call to a signal processing card with the smallest maximum size of vacant resources (hard to allocate a call with a large number of required resources) in the signal card.

In addition, by recording the traffic and increasing or decreasing dynamically the threshold to switch between (a) and (b), such an effect is obtained that enables implementation of control corresponding to a time period and/or position of the base station. For example, the call loss caused by lack of resources is hard to occur in a time period during which speech calls are dominant, and therefore, when the threshold is set at “1” that is smaller than “16” of this embodiment, load distribution can be performed in the case where the number of vacant resources is smaller than that in this embodiment.

In addition, it can be conceived easily that the same advantageous effects as in the invention are obtained by applying the invention to cases where the number of signal processing cards is different and/or signal processing cards are different from one another in the number of resources therein.

Further, the invention is also applicable to cases where the number of types of calls that can be held in base station 102 is different and/or the number of required resources for the type of call is different.

As described above, in this embodiment, wireless resource monitoring means 109 switches the resource allocating scheme by wireless resource control section 107 among three schemes corresponding to the state of signal processing section 106, and the call allocating processing is performed to distribute loads at the low traffic time, while being performed to use up resources in a card with the high in-use rate as possible at the high traffic time, whereby the advantageous effect is obtained such that loads can be distributed over signal processing cards without causing the call loss as possible by using resources with high efficiency.

### Embodiment 2

Embodiment 2 of the invention will be described below.

Embodiment 2 has the same configuration as in Embodiment 1, and the block configuration diagram thereof is the same as in FIG. 2 in Embodiment 1.

In the W-CDMA system, since a common channel is used for a base station to control communications of terminals, when a signal processing card holding the common channel develops trouble and signals cannot be transmitted on the common channel, communications fails to all the terminals held by the base station. Therefore, when detecting an abnormal condition such as failure in a signal processing card holding the common channel, such processing (hereinafter, referred to as “resource expelling”) is performed for transferring the common channel to another signal processing card with vacant resources.

However, unless vacant resources are reserved to hold the common channel other than resources to which the common channel is already allocated, communications on the common channel becomes impossible if failure occurs in the signal processing card holding the common channel. Therefore, this embodiment illustrates an algorithm for a base station to reserve resources to expel the common channel. Hereinafter, the number of required resources of the common channel is assumed common_ch. The common_ch is fixed at “8” in this embodiment. Names of the other variables and constants to use are the same as in Embodiment 1.

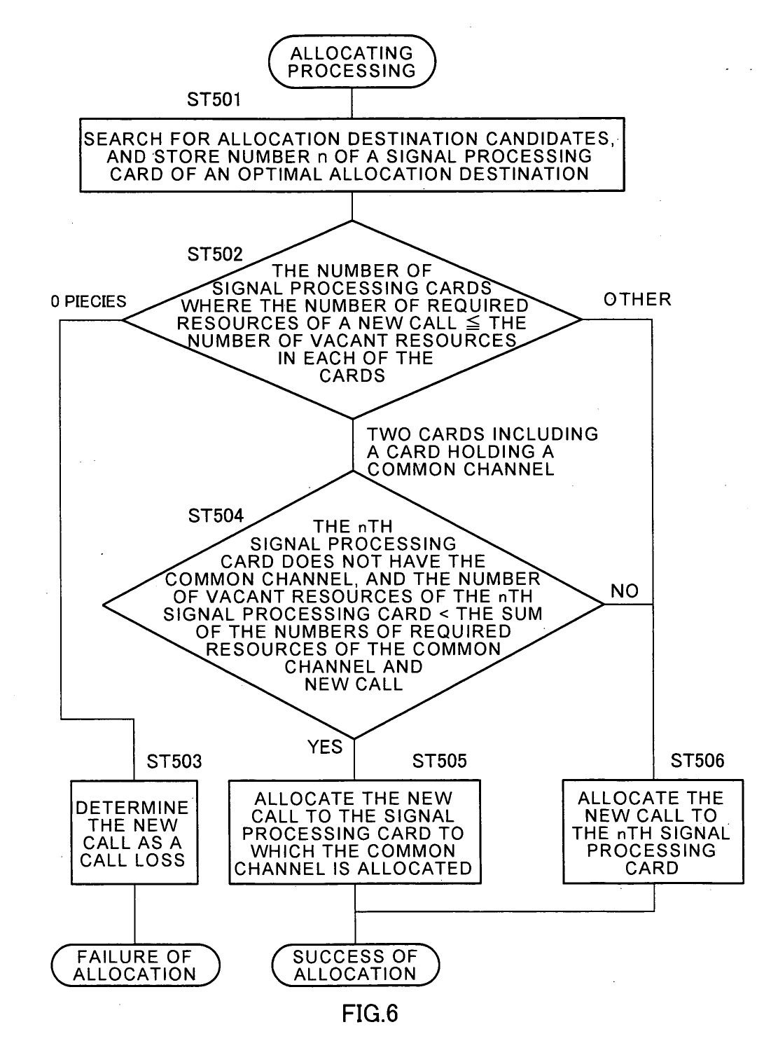

FIG. 6 is a flow diagram illustrating the algorithm of this embodiment. In this embodiment, in step ST501, an algorithm to select an optimal card (hereinafter, referred to as an allocation card search algorithm) is operated, irrespective of presence or absence of the common channel. In this embodiment, the switching algorithm described in Embodiment 1 is used as the allocation card search algorithm. In addition, it is also possible to use another scheme where the common channel is not considered, as the allocation card search algorithm.

In step ST502, a scheme of selecting a signal processing card as an allocation destination is determined from the number of cards such that new_call≦vacancy[i] (with the number of vacant resources not less than the number of required resources of a new call). In the case where such a number is zero, the call cannot be allocated to any cards, a result (allocation is impossible) of step ST501 becomes a result of this flow, and the call loss occurs (ST503). Meanwhile, when there are two or more signal processing cards enabling allocation except the signal processing card holding the common channel, even if a new call is allocated to either signal processing card, it is possible to reserve a destination to which the common channel is expelled in failure. In this case, the new call is allocated to a signal processing card searched by the allocation card search algorithm, and a result of step ST501 becomes a result of this flow (ST506).

The allocation card search algorithm differs from the algorithm of this embodiment when a signal processing card enabling allocation in step ST504 includes the signal processing card holding the common channel and another card. In this state, when a call is allocated to the card that does not hold the common channel and the number of vacant resources becomes smaller than the number of required resources of the common channel, it is not possible to expel the common channel from the resources.

Accordingly, when two cards are found to hold a new call in the allocation card search algorithm, the signal processing card holding the common channel and the other signal processing card, it is judged whether the common channel can be expelled if a new call is allocated to the other signal processing card (the number of this card is assumed “n”) that does not hold the common channel. More specifically, it becomes possible to allocate the new call to the nth signal processing card when vacancy[n]≧common_ch+new_call holds i.e. the number of vacant resources of the other card before allocation is larger than the sum of the number of required resources of the common channel and the number of required resources of the new call (ST506). In other cases, resources cannot be allocated in the card that does not hold the common channel, and the new call is allocated to the signal processing card that holds the common channel (step ST505).

In addition, in this embodiment, processing for determining an allocation destination is performed irrespective of whether or not the nth signal processing card determined as an optimal allocation destination in step ST501 holds the common channel. However, when the signal processing card holding the common channel is determined as an optimal allocation destination in processing 501, the allocation may be performed without change. When this determination is added to the flow, the same advantageous effect as in this embodiment is obtained.

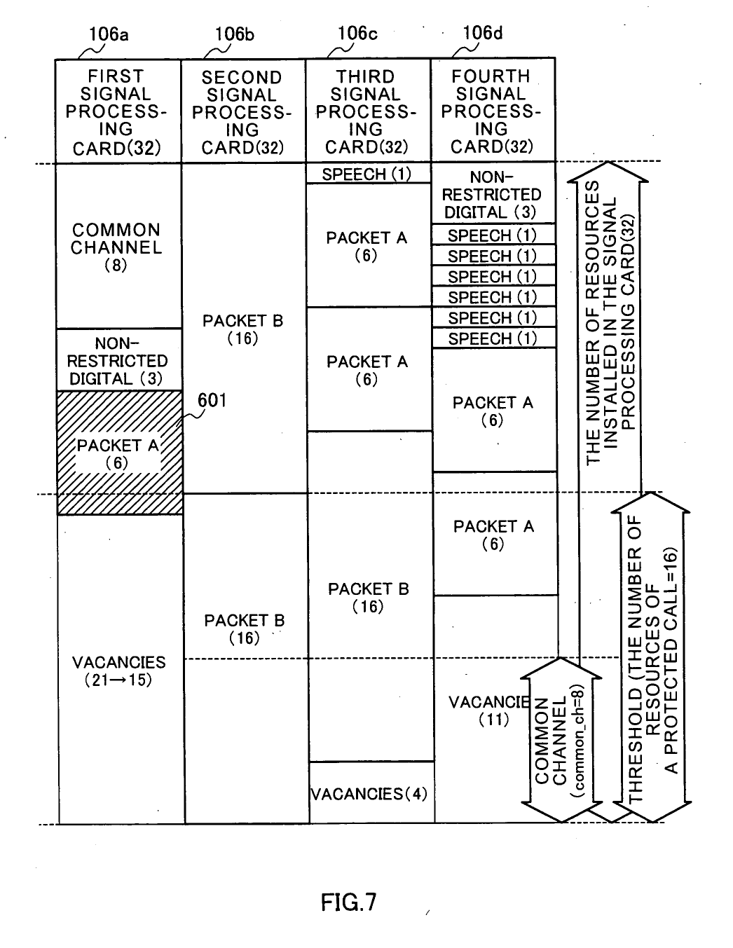

The operation at the low traffic time in this embodiment will be described below with reference to FIG. 7.

In FIG. 7, reference numerals 106a to 106d respectively denote first signal processing card 106a to fourth signal processing card 106d. When packet A call 601 occurs, the call can be allocated to fourth signal processing card 106d with eleven vacant resources (using three resources for a non-restricted digital call, six resources for speech calls, and twelve resources for packet A calls) or first signal processing card 106a with twenty one vacant resources (using eight resources for the common channel and three resources for a non-restricted digital call).

In the algorithm of Embodiment 1, since the number of vacant resources is smaller than the sum of the number (16) of required resources of protected packet B call and the number (6) of required resources of the new call both in first signal processing card 106a and fourth signal processing card 106d, the fourth signal processing card 106d with the smaller number of vacant resources is determined optimal (step ST501 in FIG. 6)

In step ST502 in FIG. 6, two cards are available for allocation including first signal processing card 106a holding the common channel, and therefore, the processing flow proceeds to step ST504. In step ST504, the number of remaining resources of fourth signal processing card 106d is eleven which is smaller than the sum of the number (8) of required resources of the common channel and the number (6) of required resources of the new call. Accordingly, if the new call is allocated to fourth signal processing card 106d, the common channel cannot be expelled from the resources of first signal processing card 106a. Therefore, in FIG. 6, determination in step ST504 results in Yes, and the processing flow proceeds to step ST505 where the new call is allocated to first signal processing card 106a.

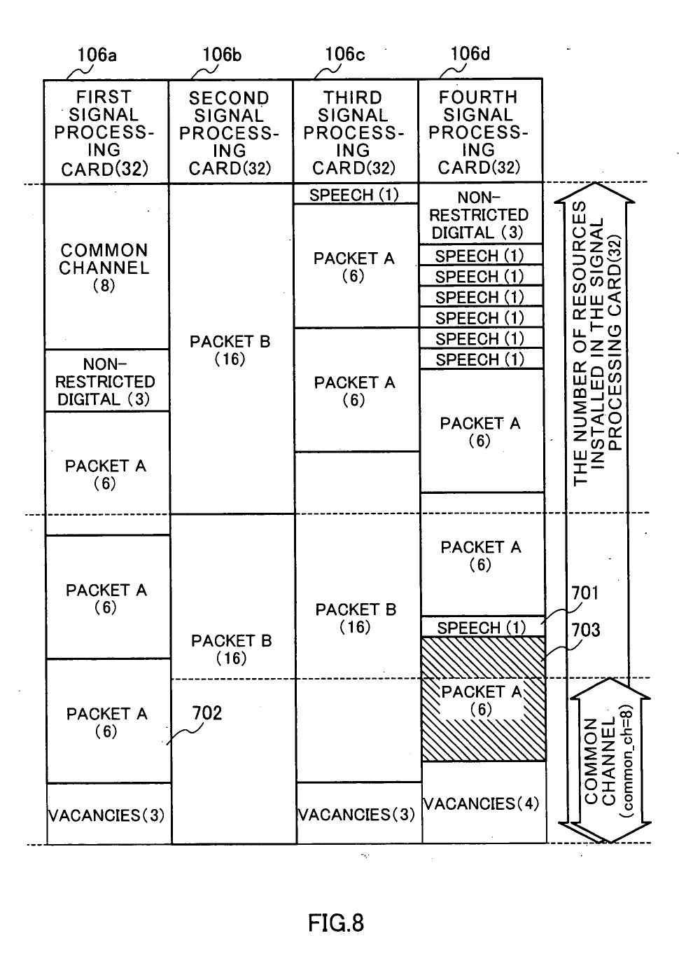

Referring to FIG. 8, the operation of this embodiment will be described below when one speech call and two packet A calls occur in the state of FIG. 7. In FIG. 8, reference numerals 106a to 106d are the same as those described in FIG. 2. FIG. 8 illustrates the allocating method when speech call 701, and packet A calls 702 and 703 occur sequentially after the allocation in FIG. 6 is carried out.

In the case of speech call 701, each number is as follows:

the number of vacant resources of first signal processing card 106a: “9”;

the number of vacant resources of fourth signal processing card 106d: “11”;

the number of required resources of a speech call: “1”; and

the number of required resources of the common channel: “8”.

Accordingly, in FIG. 6, the number of vacant resources of fourth signal processing card 106d minus the number of required resources of a speech call is equal to ten, which is larger than the number of required resources of the common channel. Accordingly, determination in step ST504 results in No, the processing flow proceeds to step ST506, and the call 701 is allocated to fourth signal processing card 106d with vacant resources larger than the sum of the numbers of required resources of the new call and common channel.

Next, in the case of packet A call 702, each number is as follows:

the number of vacant resources of first signal processing card 106a: “9”;

the number of vacant resources of fourth signal processing card 106d: “10”;

the number of required resources of a packet A call: “6”; and

the number of required resources of the common channel: “8”.

In FIG. 6, first in step ST501, fourth signal processing card 106d is determined as an optimal allocation destination by the allocation card search algorithm. At this point, the number of vacant resources of fourth signal processing card 106d is smaller than the sum of the numbers of required resources of the new call and the common channel, determination in step ST504 thereby results in Yes, the processing flow proceeds to step ST505, and the call 702 is allocated to first signal processing card 106a.

Next, in the case of packet A call 703, each number is as follows:

the number of vacant resources of first signal processing card 106a: “3”;

the number of vacant resources of fourth signal processing card 106d: “10”;

the number of required resources of a packet A call: “6”; and

the number of required resources of the common channel: “8”.

Therefore, fourth signal processing card 106d is only a card meeting required resources for the new call, determination in step ST502 in FIG. 6 results in [Other], and the processing flow proceeds to step ST506. Accordingly, the number of vacant resources of fourth signal processing card 106d is smaller than the sum of the numbers of required resources of the new call and the common channel, but the call 703 is allocated to fourth signal processing card 106d.

In addition, it can be conceived easily that the same advantageous effects as in the invention are obtained by applying the invention to cases where the number of signal processing cards is different and/or signal processing cards are different from one another in the number of resources therein.

Further, the invention is also applicable to cases where the number of types of calls that can be held in base station 102 is different and/or the number of required resources for the type of call is different.

As described above, in this embodiment, by allocating calls so as to leave vacant resources to accommodate the common channel as possible, when a signal processing card holding the common channel fails to operate properly, resources in another signal processing card can accommodate the common channel, and the advantageous effect is obtained to enable stable operation of the base station.

As described above, according to the present invention, a protected call is first set, the resource allocating scheme is varied according to the resource state of each card, call allocating processing is performed to distribute loads at the low traffic time, while being performed to use up as possible resources of a card with a high in-use rate at the high traffic time, and it is thereby possible to obtain the advantageous effect of using resources with high efficiency to enable the distribution of loads over signal processing cards without generating the call loss as possible.

Further, according to the invention, by allocating calls so as to leave vacant resources to accommodate the common channel, when a signal processing card holding the common channel fails to operate properly, resources in another signal processing card can accommodate the common channel, and the advantageous effect is obtained to enable stable operation of the base station.

This application is based on the Japanese Patent Application No. 2003-100017 filed on Apr. 3, 2003, the entire content of which is expressly incorporated by reference herein.

### INDUSTRIAL APPLICABILITY

A resource allocating method in a radio base station of the present invention is applicable to a resource management scheme to suitably allocate resources in an apparatus in a radio base station that holds terminals performing wireless communications.

1. A resource allocating method in a radio base station for allocating a plurality of types of calls to a plurality of signal processing cards, comprising at least the steps of:
registering a call of a type whose loss is to be avoided as a protected call among the plurality of types of calls;
comparing a first sum of a resource of the protected call and a resource of a new call with vacant resources of at least two signal processing cards when the new call occurs;
defining a case that the first sum is more than a vacant resource of each signal processing card as a high traffic time, while defining another case that the first sum is less than or equal to a vacant resource of either signal processing card of the at least two signal processing cards as a low traffic time; and
switching a resource allocating scheme between the high traffic time and the low traffic time.

2. The resource allocating method in the radio base station according to claim 1, further comprising the step of:
allocating the new call preferentially to a signal processing card with the smallest vacant resource among signal processing cards with vacant resources more than the resource of the new call at the high traffic time.

3. The resource allocating method in the radio base station according to claim 1, further comprising the step of:
discarding the new call when the resource of the new call is more than vacant resources of all signal processing cards.

4. The resource allocating method in the radio base station according to claim 1, further comprising the steps of:
determining a signal processing card judged as an optimal allocation destination of the new call as an allocation destination signal processing card;
comparing a second sum of the resource of the new call and a resource of a common channel with a vacant resource of the allocation destination signal processing card when the common channel is not allocated to the allocation destination signal processing card; and
allocating the new call to the allocation destination signal processing card when the second sum is less than the vacant resource of the allocation destination signal processing card, while allocating the new call to a signal processing card to which the common channel is allocated when the second sum is more than or equal to the vacant resource of the allocation destination signal processing card.

5. The resource allocating method in the radio base station according to claim 1, wherein when there are two or more signal processing cards with vacant resources more than a required resource of the new call in addition to a signal processing card holding a common channel, a signal processing card judged as an optimal allocation destination of the new call is determined as an allocation destination signal processing card.

6. A radio base station comprising:
a plurality of signal processing cards for performing signal processing on communication calls in and wireless communications; and
a wireless resource monitor which registers a call of a type whose loss is to be avoided as a protected calls among a plurality of types of calls, compares a first sum of a resource of the protected call and a resource of a new call with vacant resources of at least two signal processing cards when the new call occurs,
defines a case that the first sum is more than a vacant resource of each of the signal processing card cards as a high traffic time, while defining a case that the first sum is less than or equal to a vacant resource of either signal processing card of the at least two signal processing cards as a low traffic time, and
switches a resource allocating scheme between the high traffic time and the low traffic time.

7. The radio base station according to claim 6, wherein at the high traffic time, the wireless resource monitor allocates the new call preferentially to a signal processing card with the smallest vacant resource among signal processing cards with vacant resources more than the resource of the new call.

8. The radio base station according to claim 7, wherein the wireless resource monitor discards the new call when the resource of the new call is more than vacant resources of all signal processing cards.

9. The radio base station according to claim 6, wherein the wireless resource monitor stores a signal processing card judged as an optimal allocation destination of the new call as an allocation destination signal processing card;
compares a second sum of the resource of the new call and a resource of a common channel with a vacant resource of the allocation destination signal processing card when the common channel is not allocated to the allocation destination signal processing card; and
allocates the new call to the allocation destination signal processing card when the second sum is less than the vacant resource of the allocation destination signal processing card, while allocating the new call to a signal processing card to which the common channel is allocated when the second sum is more than or equal to the vacant resource of the allocation destination signal processing card.

10. The radio base station according to claim 9, wherein when there are two or more signal processing cards with vacant resources more than a required resource of the new call in addition to a signal processing card holding the common channel, the wireless resource monitor determines a signal processing card judged as an optimal allocation destination of the new call as an allocation destination signal processing card.

11. A resource allocating method in a radio base station for allocating a plurality of types of calls to a plurality of signal processing cards, comprising the steps of:
registering a call of a type whose loss is to be avoided as a protected call among the plurality of types of calls;
comparing a first sum of a resource of the protected call and a resource of a new call with vacant resources of at least two signal processing cards when the new call occurs; and
switching a resource allocating scheme according to a result of comparison.

12. A radio base station comprising:
a plurality of signal processing cards for performing signal processing on communication calls in wireless communications; and
a wireless resource monitor which registers a call of a type whose loss is to be avoided as a protected call among a plurality of types of calls, compares a first sum of a resource of the protected call and a resource of a new call with vacant resources of at least two signal processing cards when the new call occurs, and switches a resource allocating scheme according to a result of comparison.
